(19) United States
(12) Patent Application Publication
(10) Pub. No.: US 2026/0067600 A1
(43) Pub. Date: Mar. 5, 2026

(54) COMMUNICATION SYSTEMS AND METHODS USING HYBRID-SWITCH DYNAMIC BANDWIDTH ALLOCATION

(71) Applicant: CABLE TELEVISION LABORATORIES, INC., Louisville, CO (US)

(72) Inventors: Rujia Zou, Louisville, CO (US); Haipeng Zhang, Broomfield, CO (US); Zhensheng Jia, Superior, CO (US)

(21) Appl. No.: 19/313,543

(22) Filed: Aug. 28, 2025

Related U.S. Application Data
(60) Provisional application No. 63/688,729, filed on Aug. 29, 2024.

(51) Int. Cl. H04Q 11/00

(52) U.S. Cl. CPC H04Q 11/0067; H04Q 2011/0084; H04Q 2011/0086

(57) ABSTRACT

Communication systems and methods using a hybrid-switch dynamic bandwidth allocation (DBA) are provided. A predetermined switch threshold is calculated for each data subcarrier of a downstream optical signal. The downstream optical signal is transmitted by an optical line terminal (OLT) to a plurality of optical network units (ONUs) disposed remotely from the OLT. A status report is received from each ONU of the plurality of ONUs and a current load is calculated for each data subcarrier of the one or more data subcarriers based on the status report from each ONU. The current load is determined to meet or not meet the predetermined switch threshold. A first DBA algorithm is selected when the current load does not meet the predetermined switch threshold and a second DBA algorithm is selected when the current load meets the predetermined switch threshold. The selected DBA algorithm is then executed.

### CROSS REFERENCE TO RELATED APPLICATIONS

This application claims the benefit of U.S. Provisional Application No. 63/688,729, filed on Aug. 29, 2024, which application is incorporated herein by reference in its entirety.

### BACKGROUND

The field of the disclosure relates generally to communication systems, and more particularly, to communication systems and methods using hybrid-switch dynamic bandwidth allocation (DBA).

Advancements in communication systems (also referred to as networks or communication networks) such as, for example, coherent Passive Optical Network (CPON) technologies feature 100 G and higher data rates in which low-latency bandwidth management and efficient DBA mechanisms are crucial. Additionally, expanding demand on emerging services such as 5G mobile X-haul, edge computing, AR/VR gaming, Tactile Internet, etc. has placed additional demands on the communication systems and networks. To enable bandwidth sharing across diverse service types, DBA mechanisms are used to efficiently allocate upstream bandwidth based on real-time user demands and network conditions. However, networks conventionally assign a specific DBA mechanism that may provide efficient DBA in some scenarios, but may be inefficient in other scenarios. As such, networks may still suffer from substantial latency if the network experiences scenarios (e.g., bursty traffic or the like) in which the selected DBA mechanism is not suitable. Thus, there is a desire in the industry to improve bandwidth management and latency in communication systems and networks that experiences a variety of scenarios and demands.

### SUMMARY

The techniques of this disclosure generally relate to a hybrid-switch dynamic bandwidth allocation (DBA) in which a current load of a network is used to select and execute a DBA algorithm from a plurality of DBA algorithms. The selected DBA algorithm is determined based on whether the current load is below, meets, or is above one or more predetermined switch thresholds.

A coherent passive optical network (CPON) according to at least one embodiment of the present disclosure comprises an optical line terminal (OLT) configured to transmit a downstream optical signal to a plurality of optical network units (ONUs) disposed remotely from the OLT and to receive an upstream optical signal from each of the plurality of ONUs, each of the downstream optical signal and the upstream optical signal including one or more data subcarriers; an optical communication medium in operable communication with the OLT, and configured to transport the downstream optical signal to the plurality of ONUs and to transport the upstream optical signal to the OLT, wherein a temporal misalignment exists between execution of a DBA algorithm and the OLT receiving a status report from the plurality of ONUs; a processor; and a memory storing data for processing by the processor, the data, when processed, causes the processor to: determine a predetermined switch threshold for each data subcarrier of the one or more data subcarriers; receiving the status reports from each ONU of the plurality of ONUs; calculate a current load for each data subcarrier of the one or more data subcarriers based on the status reports; determine if the current load meets the predetermined switch threshold; select a first dynamic bandwidth allocation (DBA) algorithm of a plurality of DBA algorithms when the current load does not meet the predetermined switch threshold and a second DBA algorithm of the plurality of DBA algorithms when the current load meets the predetermined switch threshold of at least one predetermined switch threshold; and execute the selected DBA algorithm, wherein selecting and executing the selected DBA algorithm improves the temporal misalignment.

Any of the aspects herein, wherein the first DBA algorithm comprises at least one of a weighted-fair DBA algorithm, a round-robin DBA algorithm, and a priority queuing DBA algorithm.

Any of the aspects herein, wherein the second DBA algorithm comprises at least one of a weighted-fair DBA algorithm, a round-robin DBA algorithm, and a priority queuing DBA algorithm.

Any of the aspects herein, wherein the plurality of DBA algorithms comprises more than two DBA algorithms.

Any of the aspects herein, wherein the at least one predetermined switch threshold comprises more than one predetermined switch threshold.

Any of the aspects herein, wherein the current load comprises a total number of bytes of waiting packets.

Any of the aspects herein, wherein determining the at least one predetermined switch threshold includes calculating the at least one predetermined threshold based on a transmission capacity of a DBA cycle, a number of ONUs assigned to a data subcarrier of the one or more data subcarriers, and a threshold factor.

Any of the aspects herein, wherein the at least one predetermined switch threshold is determined by a threshold function based on the current load.

Any of the aspects herein, wherein the predetermined switch threshold is a first predetermined switch threshold, and wherein the processor is further configured to: determine if the current load is at least one of less than the first predetermined switch threshold, between the first predetermined switch threshold and a second predetermined switch threshold, or greater than the second predetermined switch threshold; select the first DBA algorithm when the current load does not meet the first predetermined switch threshold, select the second DBA algorithm when the current load is between the first predetermined switch threshold and the second predetermined switch threshold, and select a third DBA algorithm when the current load is greater than the second predetermined switch threshold; and execute the selected DBA algorithm.

Any of the aspects herein, wherein the processor is further configured to: monitor the current load over a time period; determine a traffic pattern based on the current load over the time period; and adjust the at least one predetermined switch threshold based on the determined traffic pattern.

A coherent passive optical network (CPON) according to at least one embodiment of the present disclosure comprises an optical line terminal (OLT) configured to transmit a downstream optical signal to a plurality of optical network units (ONUs) disposed remotely from the OLT and to receive an upstream optical signal from each of the plurality of ONUs, each of the upstream optical signal and the downstream optical signal including one or more data subcarriers; an optical fiber in operable communication with the OLT, and configured to transport the downstream optical signal to the plurality of ONUs and to transport the upstream optical signal to the OLT, wherein a temporal misalignment exists between execution of a DBA algorithm and the OLT receiving a status report from the plurality of ONUs; a processor; and a memory storing data for processing by the processor, the data, when processed, causes the processor to: receive a status report from each ONU of the plurality of ONUs, the status report comprising a queue size of the ONU and one or more network conditions; calculate a predetermined switch threshold for each data subcarrier of the one or more data subcarriers; receiving the status reports from each ONU of the plurality of ONUs; calculate a current load for each data subcarrier of the one or more data subcarriers based on the status reports for each ONU; determine if the current load meets the predetermined switch threshold; select a first dynamic bandwidth allocation (DBA) algorithm of a plurality of DBA algorithms when the current load is at least one of less than or equal to the predetermined switch threshold and a second DBA algorithm of the plurality of DBA algorithms when the current load is greater than the predetermined switch threshold of at least one predetermined switch threshold; and execute the selected DBA algorithm, wherein selecting and executing the selected DBA algorithm improves the temporal misalignment.

Any of the aspects herein, wherein the first DBA algorithm comprises at least one of a weighted-fair DBA algorithm, a round-robin DBA algorithm, and a priority queuing DBA algorithm.

Any of the aspects herein, wherein the second DBA algorithm comprises at least one of a weighted-fair DBA algorithm, a round-robin DBA algorithm, and a priority queuing DBA algorithm.

Any of the aspects herein, wherein the plurality of DBA algorithms comprises more than two DBA algorithms.

Any of the aspects herein, wherein the at least one predetermined switch threshold comprises more than one predetermined switch threshold.

Any of the aspects herein, wherein the processor is further configured to: monitor the current load over a time period; determine a traffic pattern based on the current load over the time period; and adjust the at least one predetermined switch threshold based on the determined traffic pattern.

Any of the aspects herein, wherein determining the at least one predetermined switch threshold includes calculating the at least one predetermined threshold based on a transmission capacity of a DBA cycle, a number of ONUs assigned to a data subcarrier of the one or more data subcarriers, and a threshold factor.

Any of the aspects herein, wherein the at least one predetermined switch threshold is determined by a threshold function based on the current load.

Any of the aspects herein, wherein the CPON uses at least one of time-division multiplexing or time and frequency division multiplexing.

A method for hybrid-switch dynamic bandwidth allocation (DBA) according to at least one embodiment of the present disclosure comprises calculating a predetermined switch threshold for each data subcarrier of one or more data subcarriers of a downstream optical signal, the downstream optical signal transmitted by an optical line terminal (OLT) to a plurality of optical network units (ONUs) disposed remotely from the OLT; receiving a status report from each ONU of the plurality of ONUs; calculating a current load for each data subcarrier of the one or more data subcarriers based on the status report from each ONU; determining if the current load meets the predetermined switch threshold; selecting a first DBA algorithm of a plurality of DBA algorithms when the current load does not meet the predetermined switch threshold and a second DBA algorithm of the plurality of DBA algorithms when the current load meets the predetermined switch threshold of at least one predetermined switch threshold; and executing the selected DBA algorithm.

The details of one or more aspects of the disclosure are set forth in the accompanying drawings and the description below. Other features, objects, and advantages of the techniques described in this disclosure will be apparent from the description and drawings, and from the claims.

The preceding is a simplified summary of the disclosure to provide an understanding of some aspects of the disclosure. This summary is neither an extensive nor exhaustive overview of the disclosure and its various aspects, embodiments, and configurations. It is intended neither to identify key or critical elements of the disclosure nor to delineate the scope of the disclosure but to present selected concepts of the disclosure in a simplified form as an introduction to the more detailed description presented below. As will be appreciated, other aspects, embodiments, and configurations of the disclosure are possible utilizing, alone or in combination, one or more of the features set forth above or described in detail below.

Numerous additional features and advantages of the present invention will become apparent to those skilled in the art upon consideration of the embodiment descriptions provided hereinbelow.

### BRIEF DESCRIPTION OF THE DRAWINGS

The accompanying drawings are incorporated into and form a part of the specification to illustrate several examples of the present disclosure. These drawings, together with the description, explain the principles of the disclosure. The drawings simply illustrate preferred and alternative examples of how the disclosure can be made and used and are not to be construed as limiting the disclosure to only the illustrated and described examples. Further features and advantages will become apparent from the following, more detailed, description of the various aspects, embodiments, and configurations of the disclosure, as illustrated by the drawings referenced below.

FIG. 1 is a schematic illustration of an example coherent passive optical network (CPON) system according to at least one embodiment of the present disclosure;

FIG. 2 is a schematic illustration of a dynamic bandwidth allocation (DBA) cycle according to at least one embodiment of the present disclosure;

FIG. 3 is a flowchart according to at least one embodiment of the present disclosure;

FIG. 4A is a schematic illustration of a time diagram of a DBA cycle according to at least one embodiment of the present disclosure;

FIG. 4B is a schematic illustration of a communication system at t0 of the time diagram of FIG. 4A according to at least one embodiment of the present disclosure;

FIG. 4C is a schematic illustration of the communication system at t2 of the time diagram of FIG. 4A using a Round Robin (RR) DBA algorithm according to at least one embodiment of the present disclosure;

FIG. 4D is a schematic illustration of the communication system at t2 of the time diagram of FIG. 4A using a Weighted Fair (WF) DBA algorithm according to at least one embodiment of the present disclosure;

FIG. 4E is a schematic illustration of the communication system at t3 of the time diagram of FIG. 4A using the RR DBA algorithm according to at least one embodiment of the present disclosure;

FIG. 4F is a schematic illustration of the communication system at t3 of the time diagram of FIG. 4A using the WF DBA algorithm according to at least one embodiment of the present disclosure;

FIG. 5 is a graphical illustration of a plot showing an average latency of three DBA algorithms with different traffic loads according to at least one embodiment of the present disclosure;

FIG. 6 is a graphical illustration of a plot showing an average latency of three DBA algorithms with a different number of optical network units according to at least one embodiment of the present disclosure;

FIG. 7A is a graphical illustration of a plot showing an average latency of three DBA algorithms of a first service group according to at least one embodiment of the present disclosure; and

FIG. 7B is a graphical illustration of a plot showing an average latency of three DBA algorithms of a second service group according to at least one embodiment of the present disclosure.

### DETAILED DESCRIPTION

The singular forms “a,” “an,” and “the” include plural references unless the context clearly dictates otherwise.

“Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about,” “approximately,” and “substantially,” are not to be limited to the precise value specified. In at least some instances, the approximating language may correspond to the precision of an instrument for measuring the value. Here and throughout the specification and claims, range limitations may be combined and/or interchanged; such ranges are identified and include all the sub-ranges contained therein unless context or language indicates otherwise.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together. When each one of A, B, and C in the above expressions refers to an element, such as X, Y, and Z, or class of elements, such as X₁-Xₙ, Y₁-Yₘ, and Z₁-Z₀, the phrase is intended to refer to a single element selected from X, Y, and Z, a combination of elements selected from the same class (i.e., X₁ and X₂) as well as a combination of elements selected from two or more classes (i.e., Y₁ and Z₀).

As used herein, the term “database” may refer to either a body of data, a relational database management system (RDBMS), or to both, and may include a collection of data including hierarchical databases, relational databases, flat file databases, object-relational databases, object-oriented databases, and/or another structured collection of records or data that is stored in a computer system.

As used herein, the terms “processor” and “computer” and related terms, i.e., “processing device”, “computing device”, and “processor” are not limited to just those integrated circuits referred to in the art as a computer, but broadly refers to a microprocessor, a microcomputer, a programmable logic processor (PLC), an application specific integrated circuit (ASIC), and other programmable circuits, and these terms are used interchangeably herein. In the embodiments described herein, memory may include, but is not limited to, a computer-readable medium, such as a random access memory (RAM), and a computer-readable non-volatile medium, such as flash memory. Alternatively, a floppy disk, a compact disc-read only memory (CD-ROM), a magneto-optical disk (MOD), and/or a digital versatile disc (DVD) may also be used. Also, in the embodiments described herein, additional input channels may be, but are not limited to, computer peripherals associated with an operator interface such as a mouse and a keyboard. Alternatively, other computer peripherals may also be used that may include, for example, but not be limited to, a scanner. Furthermore, in the exemplary embodiment, additional output channels may include, but not be limited to, an operator interface monitor.

Further, as used herein, the terms “software” and “firmware” are interchangeable, and include computer program storage in memory for execution by personal computers, workstations, clients, and servers.

As used herein, the term “non-transitory computer-readable media” is intended to be representative of any tangible computer-based device implemented in any method or technology for short-term and long-term storage of information, such as, computer-readable instructions, data structures, program modules and sub-modules, or other data in any device. Therefore, the methods described herein may be encoded as executable instructions embodied in a tangible, non-transitory, computer readable medium, including, without limitation, a storage device and a memory device. Such instructions, when executed by a processor, cause the processor to perform at least a portion of the methods described herein. Moreover, as used herein, the term “non-transitory computer-readable media” includes all tangible, computer-readable media, including, without limitation, non-transitory computer storage devices, including, without limitation, volatile and nonvolatile media, and removable and non-removable media such as a firmware, physical and virtual storage, CD-ROMs, DVDs, and any other digital source such as a network or the Internet, as well as yet to be developed digital means, with the sole exception being a transitory, propagating signal.

Furthermore, as used herein, the term “real-time” refers to at least one of the time of occurrence of the associated events, the time of measurement and collection of predetermined data, the time for a computing device (i.e., a processor) to process the data, and the time of a system response to the events and the environment. In the embodiments described herein, these activities and events occur substantially instantaneously.

As used herein, “modem termination system” (MTS) refers to a termination unit including one or more of an Optical Network Terminal (ONT), an optical line termination (OLT), a network termination unit, a satellite termination unit, a cable modem termination system (CMTS), and/or other termination systems which may be individually or collectively referred to as an MTS. The ONT may also be referred to as an optical network unit (ONU).

As used herein, “modem” refers to a modem device, including one or more a cable modem (CM), a satellite modem, an ONU, a DSL unit, etc., which may be individually or collectively referred to as modems.

As used herein, the term “coherent transceiver,” unless specified otherwise, refers to a P2P or P2MP coherent optics transceiver having a coherent optics transmitting portion and a coherent optics receiving portion. In some instances, the transceiver may refer to a specific device under test (DUT) for several of the embodiments described herein.

As described herein, a “PON” generally refers to a passive optical network or system having components labeled according to known naming conventions of similar elements that are used in conventional PON systems. For example, an OLT may be implemented at an aggregation point, such as a headend/hub, and multiple ONUs may be disposed and operable at a plurality of end user, customer premises, or subscriber locations. Accordingly, an “uplink transmission” refers to an upstream transmission from an end user to a headend/hub, and a “downlink transmission” refers to a downstream transmission from a headend/hub to the end user, which may be presumed to be generally broadcasting continuously (unless in a power saving mode, or the like).

The person of ordinary skill in the art will understand that the term “wireless,” as used herein in the context of optical transmission and communications, including free space optics (FSO), generally refers to the absence of a substantially physical transport medium, such as a wired transport, a coaxial cable, or an optical fiber or fiber optic cable.

As used herein, the term “data center” generally refers to a facility or dedicated physical location used for housing electronic equipment and/or computer systems and associated components, i.e., for communications, data storage, etc. A data center may include numerous redundant or backup components within the infrastructure thereof to provide power, communication, control, and/or security to the multiple components and/or subsystems contained therein. A physical data center may be located within a single housing facility, or may be distributed among a plurality of co-located or interconnected facilities. A ‘virtual data center’ is a non-tangible abstraction of a physical data center in a software-defined environment, such as software-defined networking (SDN) or software-defined storage (SDS), typically operated using at least one physical server utilizing a hypervisor. A data center may include as many as thousands of physical servers connected by a high-speed network.

As used herein, the term “hyperscale” refers to a computing environment or infrastructure including multiple computing nodes, and having the capability to scale appropriately as increased demand is added to the system, i.e., seamlessly provision infrastructure components and/or add computational, networking, and storage resources to a given node or set of nodes. A hyperscale system, or “hyperscaler” may include hundreds of data centers or more, and may include distributed storage systems. A hyperscale system may utilize redundancy-based protection and/or erasure coding, and may be typically configured to increase background load proportional to an increase in cluster size. A hyperscale node may be a physical node or a virtual node, and multiple virtual nodes may be located on the same physical host. Hyperscale management may be hierarchical, and a “distance” between nodes may be physical or perceptual. A hyperscale datacenter may include several performance optimized datacenters (PODs), and each POD may include multiple racks and hundreds and thousands of compute and/or storage devices.

Exemplary CPON architectures, as well as the respective components thereof, are described in greater detail in U.S. Pat. Nos. 9,912,409, 10,200,123, and 10,523,356. Exemplary systems and methods for coherent burst reception are described in greater detail in U.S. Pat. Nos. 11,575,448 and 11,540,032. An exemplary rate-flexible CPON is described in co-pending U.S. patent application Ser. No. 18/905,880, filed Oct. 3, 2024. The disclosures of all of these prior patents and patent applications are incorporated by reference herein in their entireties.

As described above, the techniques of this disclosure generally relate to an adaptive TFDM CPON system that allows each digital subcarrier to adapt its transmission characteristics such as, for example, modulation format and/or baud rate, to enhance the efficiency and adaptability of the TFDM CPON system based on end user's needs as they change over time. The adaptive TFDM CPON system described herein also provides for digital subcarrier modulation directly in the digital domain and can be implemented in existing networks without requiring additional or new components. For example, in IM-DD PONs, additional hardware is usually required for out-of-band (OOB) communication channels. In the adaptive TFDM CPON described herein, the OOB channels can be integrated directly in the digital domain.

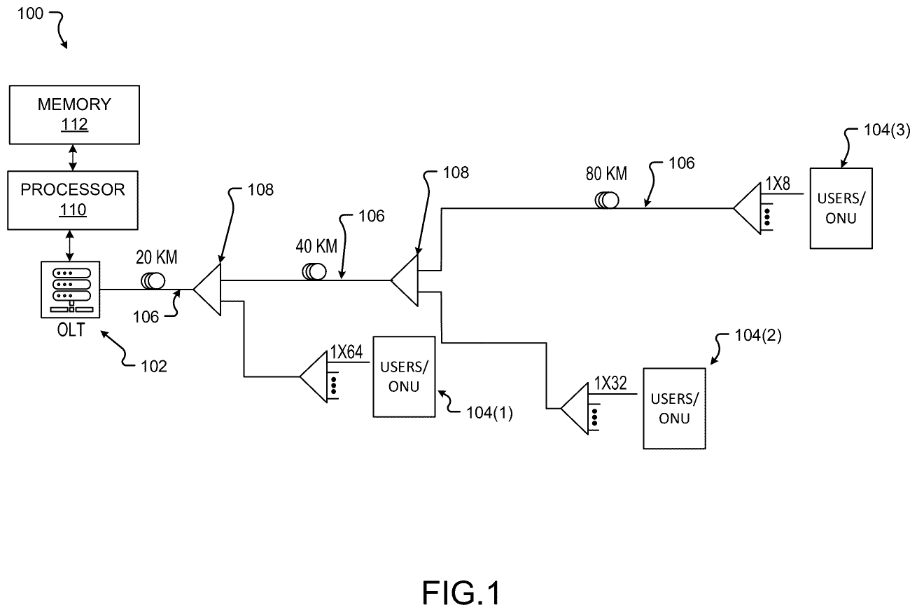

Turning to FIG. 1, a schematic illustration depicting an example CPON system (100) is provided. In the illustrated embodiment, the CPON system (100) includes a centralized optical line terminal (OLT) (102) in operable communication with a plurality (i.e., 1-N) of end-users (104(1-3)) (i.e., including respective transceivers thereof, such as ONUs, customer premises equipment (CPEs), modems, etc.). An optical communication medium (106) connects the OLT (102) to respective end-users (104) through at least one power splitter (108) connecting the various portions of the optical communication medium (106) in serial and/or in parallel.

In at least one embodiment, the OLT (102) may be located within a central office, a communications hub, or a headend of an optical link (not separately shown in FIG. 1), and functions to convert standard signals from a service provider (also not shown) to the various frequencies, modulation formats, baud rates, and framing used by the CPON system (100). In at least one embodiment, the optical communication medium (106) may include a single mode fiber (SMF), and the power splitters (108) may include a passive splitter and/or a power splitter/combiner. The OLT (102) is configured to transmit a downstream optical signal to the ONUs (104) disposed remotely from the OLT (102) via the optical communication medium (106). The OLT (102) also receives an upstream optical signal from each of the ONUs (104) via the optical communication medium (106).

In at least one embodiment, the CPON system (100) implements TFDM technology to enable multiple optical signals to share the same fiber link (i.e., optical communication medium (106)) by allocating distinct digital data subcarriers to each signal to and from a respective end-user (104). In at least one embodiment, within each allocated subcarrier, time slots facilitate data transmission to/from various users or services. In other embodiments, the CPON system (100) may implement other multiplexing technologies such as, for example, Time Division Multiplexing (TDM), Frequency Division Multiplexing (FDM), Wavelength Division Multiplexing (WDM), etc.

In the illustrated embodiment, the CPON system (100) also includes a processor (110). The processor (110) may include a processor and a memory for executing any of the functions or methods described herein as being carried out by the processor (110). The processor (110) and the memory (112) may be a standalone component in some embodiments or integrated in the OLT (102) in other embodiments.

It will be appreciated that the CPON system (100) shown is an example CPON system (100) and the CPON system (100) can include more or less components such as ONUs and/or splitters, and any length of optical communication medium.

As previously described, the CPON system (100) may use a DBA algorithm to allocate upstream bandwidth based on user demands and congestion conditions of the CPON system (100). An example DBA cycle will be described below.

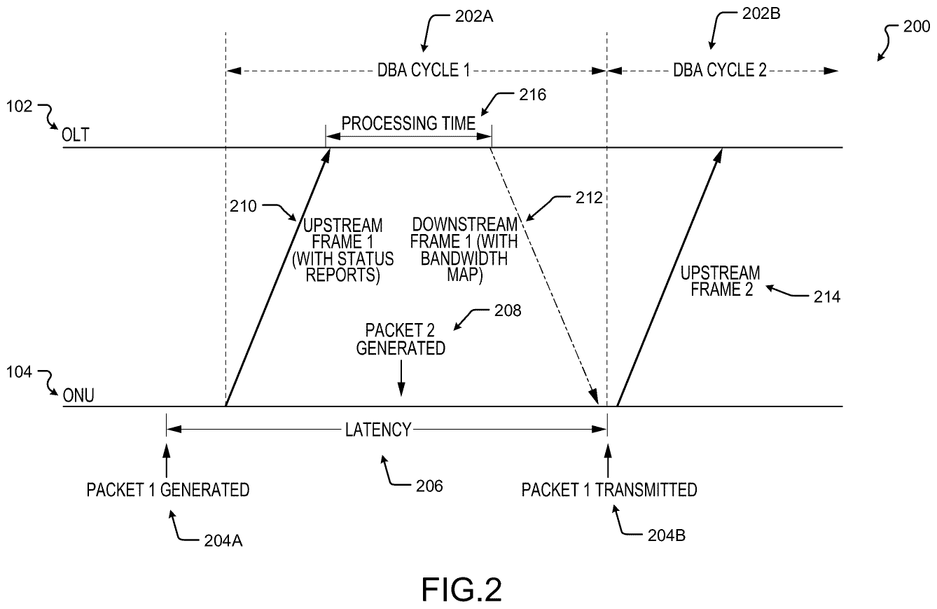

FIG. 2 illustrates an example DBA cycle (200) according to at least one embodiment of the present disclosure. The DBA cycle (200) begins with a continuous monitoring of data queues at each ONU (104). Each ONU (104) tracks a size of a transmit queue that represents the data that is awaiting transmission to the OLT (102). In a status-reporting DBA, the ONUs (104) periodically report their queue sizes and network conditions in a status report to the OLT (102) in an upstream signal (210). The status reports provide the OLT (102) with the queue information to make informed decisions about resource allocation.

Once the OLT (102) receives the upstream signal (210) with the status reports, the OLT (102) starts to process and execute a first cycle of a DBA algorithm (202A) and calculates a bandwidth map (BWmap). The BWmap carries a transmission start time and a grant size for each ONU (104) for the next cycle (e.g., a second DBA cycle (202B) in the illustrated example). The BWmap is broadcasted to all the ONUs (104) in a downstream signal (212). Once the ONUs (104) receive the downstream frame, each ONU (104) transmits its data during its allocated time slots based on the granted size and starts a new DBA cycle such as the second DBA cycle 202B and sends a second upstream frame (214).

During the processing and executing of the DBA algorithm, the traffic keeps generating packets at the same time (e.g., packet 2 in the example) (208). The packets are generated as the user data for each ONU (104) and are stored in a queue of each ONU (104) before the transmission. A latency (206) of a packet is defined as a time gap between a packet transmission time (204B) and a packet generation time (204A). Thus, at least one objective of the DBA algorithm is to minimize the average latency (206) of all the packets.

As previously described, a DBA algorithm assigned for the CPON system (100) may be efficient for certain types of user behavior and/or network conditions, but inefficient for other types of user behavior and/or network conditions due to, for example, the latency (206) described above. Further, a temporal misalignment exists between execution of a DBA algorithm and cycle and an OLT receiving a status report from each ONU of a plurality of ONUs. In other words, the temporal misalignment is between network management and network monitoring. Thus, it is desirable to have a CPON system (100) that can monitor network conditions and select a DBA algorithm best suited for the given network conditions, as described in more detail below.

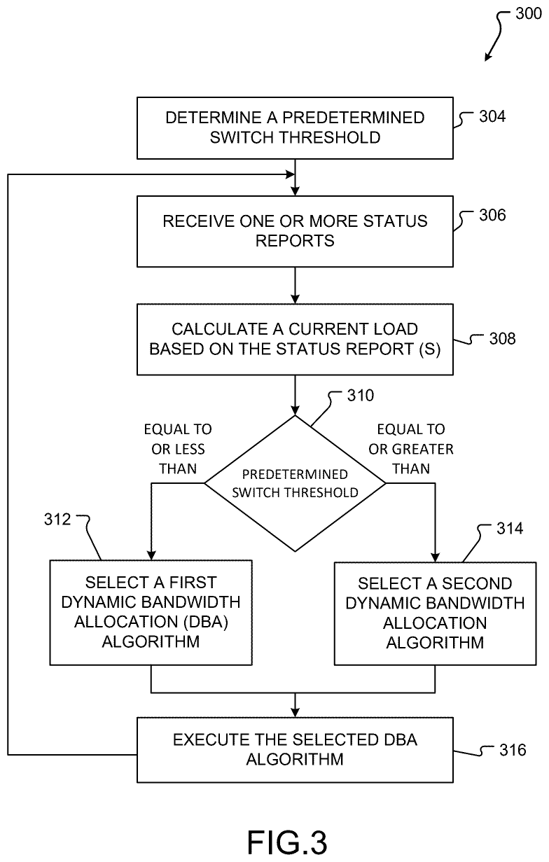

FIG. 3 illustrates a flowchart for a method (300) of using hybrid-switch DBA in a communication network. The hybrid-switch DBA improves the temporal misalignment that exists between execution of a DBA algorithm and an OLT receiving a status report from each ONU of a plurality of ONUs, as will be described below. Though the systems and methods herein describe a temporal misalignment, the hybrid-switch DBA may also beneficially improve other misalignments that may exist in the communication network.

At a step (304), a predetermined switch threshold is determined. The predetermined switch threshold may be determined by, for example, a processor such as the processor (110). The processor (110) may be part of, for example, an OLT such as the OLT (102). The predetermined switch threshold may be determined for each data subcarrier of one or more data subcarriers of a communication system. The communication system may be, for example, the CPON system (100). The data subcarriers may be transmitted in a downstream optical signal from an ONU such as the ONU (104) to the OLT or in an upstream optical signal from the OLT to the ONU(s).

The predetermined switch threshold may include one predetermined switch threshold, two predetermined switch thresholds, or more than two predetermined switch thresholds. The predetermined switch threshold may be determined based on a transmission capacity of a DBA cycle, a number of ONUs assigned to a data subcarrier, and/or a threshold factor. In some embodiments, the predetermined switch threshold may be calculated based on the following equation:

$$Predetermined Switch Threshold = ∝ \times \frac{C}{N}$$

Wherein α is a threshold factor, C is a transmission capacity of each DBA cycle (for example, 125 microseconds) of a subcarrier or a channel, and N is a number of ONUs assigned to the subcarrier.

In other embodiments, the predetermined switch threshold is determined by a threshold function based on a current load of the communication system.

At a step (306), one or more status reports are received. The one or more status reports are received by the OLT from each ONU. The status reports can include information such as, for example, queue sizes and network conditions. The queue sizes are a size of a transmit queue that represents data that is awaiting transmission to the OLT. The network conditions can include various conditions and states such as, for example, bandwidth, latency, packet loss, etc.

At a step (308), a current load is calculated based on the one or more status reports. The current load may be calculated by, for example, the processor. The current load may, for example, include a total number of bytes of waiting packets.

At a step (310), the current load is compared to the predetermined switch threshold. The current load may be compared to the predetermined switch threshold by, for example, the processor. In some embodiments, the current load is compared to one predetermined switch threshold. In such embodiments, the current load is compared to the predetermined switch threshold to determine if the current load is below, meets, or exceeds the predetermined switch threshold.

In other embodiments, the predetermined switch threshold may include two or more predetermined switch thresholds. In such embodiments, the current load may be compared to the two predetermined switch thresholds to determine which range of predetermined switch thresholds the current load is between. For example, the current load may be determined to have exceeded a first predetermined switch threshold and is between a second predetermined switch threshold and a third predetermined switch threshold. In another example, the current load may be determined to have exceeded three predetermined switch thresholds. In any example, the current load may be compared to any number of predetermined switch thresholds.

At a step (312), a first DBA algorithm is selected when the current load is equal to or less than the predetermined switch threshold. The first DBA algorithm may be selected by, for example, the processor. At a step (314), a second DBA algorithm is selected when the current load is equal to or greater than the predetermined switch threshold. The second DBA algorithm may be selected by, for example, the processor. The first DBA algorithm and the second DBA algorithm may be, for example, a WF DBA algorithm, a RR DBA algorithm, a priority queuing DBA algorithm, or any other DBA algorithm.

The method (300) may include more steps similar to the steps (312) and (314) when more than two DBA algorithms and more than two predetermined switch thresholds are utilized. For example, the method (300) may include an additional step to select a third DBA algorithm when the current load is above a first predetermined switch threshold and a second predetermined switch threshold.

Further, in some embodiments, the predetermined switch threshold(s) and/or the number of predetermined switch threshold(s) may be dynamically adjusted over time based on measured traffic patterns. In such embodiments, the method (300) may further include the steps of monitoring the current load over a time period, determining a traffic pattern based on the current load over the time period, and adjusting one or more predetermined switch thresholds based on the determined traffic pattern.

At a step (316), the selected DBA algorithm is executed. The selected DBA algorithm may be executed by, for example, the processor. After the selected DBA algorithm is executed, the method (300) may repeat beginning at the (306).

The method (300) described above can include more or less steps. Additionally, one or more steps or any combination of steps can also be repeated. In the illustrated embodiment, the method (300) can repeat after the step (316) and begin again at the step (306) such that the system is monitored continuously or at a time interval. Further, the hybrid-switch DBA enables the communication system or network to adapt in real-time to changing network conditions and select appropriate DBA algorithms for different network conditions.

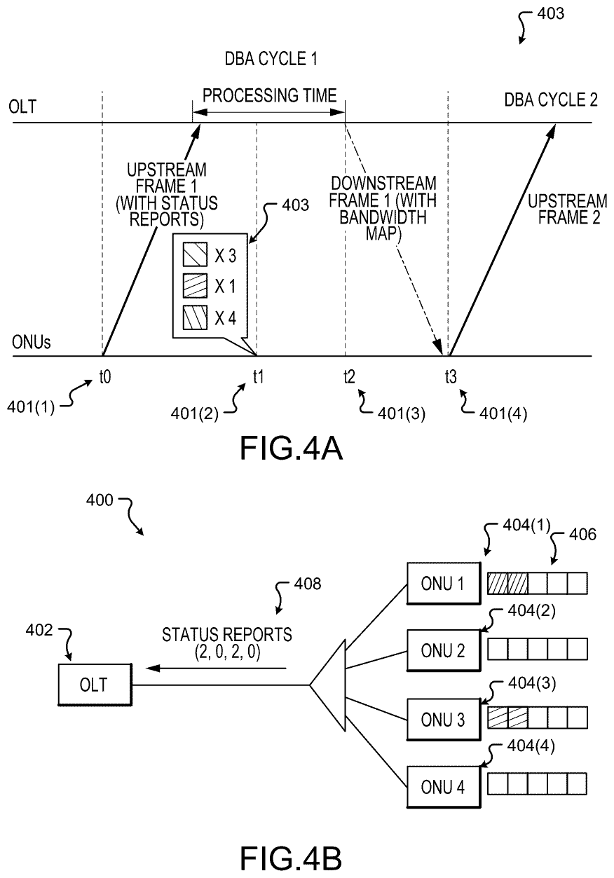

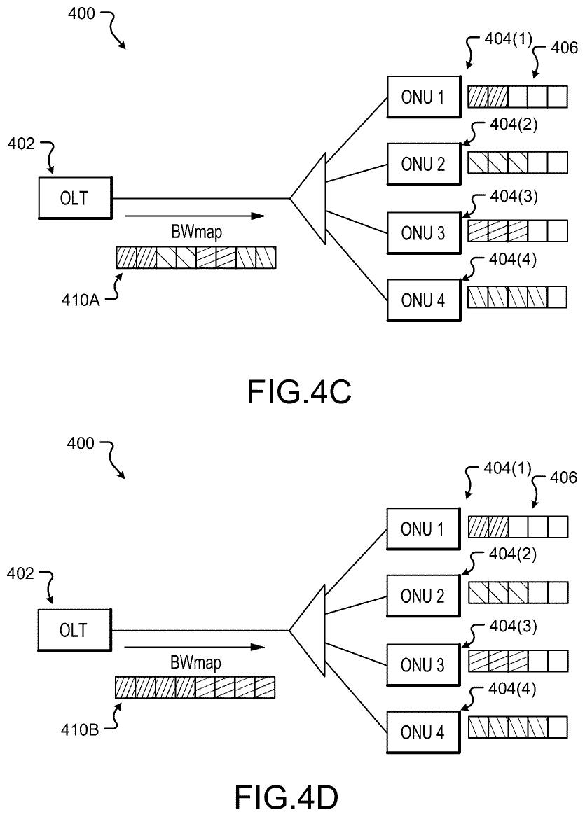

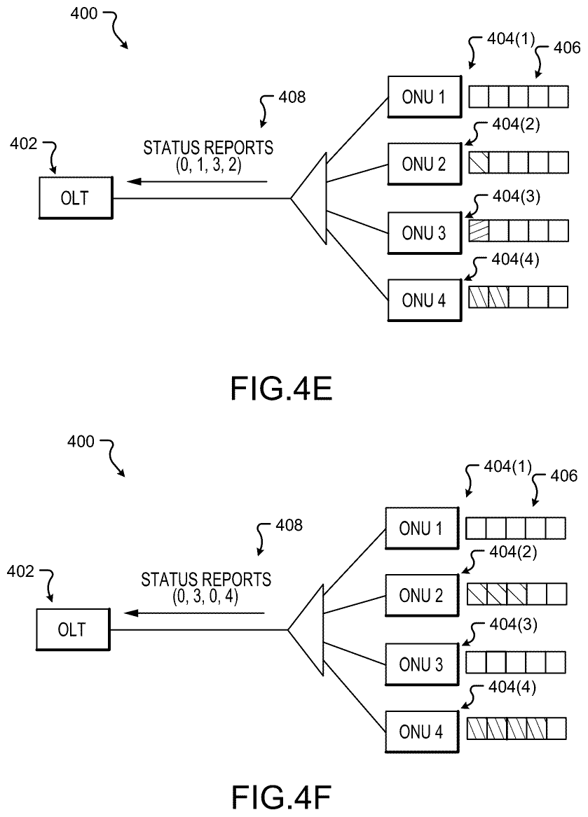

FIGS. 4A-4F illustrate an example of two DBA algorithms that can be used, for example, in the method (300) described above. The example described in FIGS. 4A-4F also illustrate the issue with relying on one DBA algorithm for a communication system and further highlights the benefits of the hybrid-switch DBA in a communication system. It will be appreciated that the two DBA algorithms described herein are shown for the purpose of illustrating differences between two example DBA algorithms. The present disclosure is not limited to the DBA algorithms described below and can utilize any DBA algorithm.

FIG. 4A is a schematic illustration of a time diagram (403) of a DBA cycle according to at least one embodiment of the present disclosure. The time diagram (403) illustrates time at a t0 (401(1)), a t1 (401(2)), a t2 (401(3)), and a t3 (401(4)), which will be referenced below.

FIG. 4B is a schematic illustration of a communication system (400) at the t0 (401(1)) of the time diagram of FIG. 4A. The communication system (400) may be the same as or similar to the CPON system (100). The communication system (400) is shown at an initial state of the communication system (400) with two packets (406) waiting in a queue of ONU 1 (404(1)) and ONU 3 (404(3)), whereas ONU 2 (404(2)) and ONU 4 (404(4)) are idle. A queue size of each ONU (404) can be measured by a number of waiting packets. Thus, a status report (408) can be measured as (2, 0, 2, 0), which are the numbers of packets in ONUs (404). The status reports (408) are then sent to the OLT (402) for a DBA calculation.

FIG. 4C is a schematic illustration of the network at t2 (401(2)) of the time diagram of FIG. 4A using a Round Robin (RR) DBA algorithm and FIG. 4D is a schematic illustration of the network at t2 (401(2)) of the time diagram of FIG. 4A using a Weighted Fair (WF) DBA algorithm according to at least one embodiment of the present disclosure.

For reference, the RR DBA algorithm is an algorithm generally used in PONs for an allocation of upstream bandwidth resources to ONUs. The RR DBA algorithm is designed to distribute available bandwidth uniformly among the ONUs to ensure that all ONUs receive equal treatment and opportunities to transmit data. However, in high network load scenarios, the RR DBA algorithm may lead to inefficient resource allocation, thereby causing network congestion and increased average latency. The inefficient resource allocation during congestion can accumulate very fast due to the high network load and can degrade a general Quality of Service (QoS) and lead to an inevitably congested network condition. Meanwhile, when ONUs have low data or even no data to transmit during their allocated time slots, bandwidth resources may still be allocated and used, leading to an inefficient utilization of available bandwidth.

Turning to the WF DBA algorithm, the WF DBA algorithm is an adaptive algorithm used in PONs to allocate upstream bandwidth resources based on the queue size of each ONU. ONUs with larger queues are granted more bandwidth to transmit their data, while ONUs with smaller queues receive proportionally smaller grants. The WF DBA algorithm ensures that ONUs with higher data loads have a greater opportunity to transmit their data to prevent potential bottlenecks and avoid potential large latency caused by the in-balance traffic pattern. The WF DBA algorithm also avoids over-allocating resources to ONUs with lower data loads, thereby improving overall network efficiency.

However, the WF DBA algorithm does not address bursty traffic effectively. If some ONUs occasionally have short but high-priority bursts of data, the WF DBA algorithm may not provide them with the appropriate resources in a timely manner due to the temporal misalignment previously described. The WF DBA algorithm makes decisions based on the queue size but the queue size changes very fast along with bursty traffic and introduces latency. For example, a large number of packets are generated from the ONUs between two upstream frames. Since the BWmap is calculated based on the queue size information carried by the previous frame but executed after the generation of those packets, the new incoming packets have to wait for the next cycle to be transmitted. When the traffic load is low, the misalignment is more severe since the bursty traffic can dramatically change the network traffic.

Turning back to the Figures, BWmaps (410) are calculated by the OLT (402) and are shown in FIG. 4C and FIG. 4D for the RR DBA algorithm and the WF DBA algorithm, respectively. Assuming that each upstream frame is able to carry 8 packets, in the BWmap (410A) of the RR DBA algorithm, the bandwidth is equally assigned to 4 ONUs (404), even though the queue size values of ONU 2 (404(2)) and ONU 4 (404(4)) in the status reports (408) are both 0. In the BWmap (410B) of the WF DBA algorithm, the bandwidth is shared by ONU 1 (404(1)) and ONU 3 (404(3)). During t1 (401(2)), which occurs during the DBA cycle time, 3 packets from ONU 2 (404(2)), 1 packet from ONU 3 (404(3)), and 4 packets from ONU 4 (404(4)) are created, shown in a box (402) in FIG. 3(A).

FIG. 4E is a schematic illustration of the network at t3 (401(4)) using the RR DBA algorithm and FIG. 4F is a schematic illustration of the network at t3 (401(4)) using the WF DBA algorithm according to at least one embodiment of the present disclosure. The new queue conditions for the ONUs (404) are updated and shown in FIG. 4E and FIG. 4F for the RR DBA algorithm and the WF DBA algorithm, respectively. In FIG. 4(E) and FIG. 4(F), the upstream frame is formed according to two BWmaps at t3 (401(4)).

The example described in FIGS. 4A-4F above illustrate that even though the RR DBA algorithm does not consider a queue size of the ONU, the new packets are transmitted on time. On the other hand, the WF DBA algorithm makes decisions based on the status reports. However, due to the temporal misalignment of the DBA, there are more packets waiting for the next round in the WF DBA algorithm because the new packets generated during the DBA process time are considered by the OLT. More specifically, the status reports provided by the ONUs at time t0 (403(1)) are not current when its corresponding BWmap is executed at time t3 (403(4)). Such examples illustrate that the WF DBA algorithm is not always more efficient than the RR DBA algorithm. As such, the RR DBA algorithm may be more efficient than the WF DBA algorithm in scenarios where the temporal misalignment is increased. Thus, the hybrid-switch DBA mechanism described in FIG. 3 is beneficial in enabling a communication system to determine and select a DBA algorithm that is most efficient for different loads and scenarios that the communication system experiences.

### Experimental Demonstrations

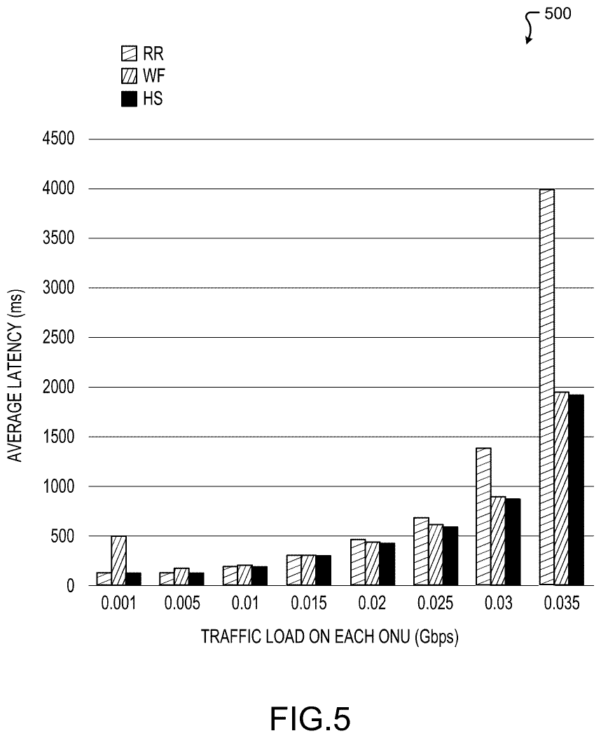

To demonstrate utility of the above embodiments, an experimental setup and results described in FIGS. 5-7B was configured to demonstrate real-world implementations of a communication system such as the CPON system (100) of FIG. 1 using hybrid-switch DBA. The experimental results verify the capability of the present CPON system with hybrid-switch DBA to effectively reduce latency in real-time in various conditions of the CPON system.

In the experimental setup, a software network simulator for upstream DBA in CPONs is used. In the CPON system, there is 1 OLT and N-number of ONUs. For each ONU, a round trip time (RTT) is randomly selected between 80 to 120 microseconds and an unlimited buffer is deployed on each ONU to store the waiting packets. All waiting packets are sorted in terms of the arrival time and every ONU belongs to a pre-determined user group.

For the traffic, packets are dynamically generated from ONUs according to a Poisson process with different arrival rates and a size of the packet ranges from 64 to 1518 bytes. In order to simulate the traffic pattern as real traffic from network users, the traffic generation rates of the ONUs are changed during the simulation. A ‘busy hour’ is created every [Pmin, Pmax], and last [Lmin, Lmax]. During the busy hour, the packet arrival rate increases with a busy hour ratio b. In this experiment, the Pmin, Pmax, Lmin, and Lmax are set to 2000, 3000, 500, and 1000 microseconds, respectively.

The upstream channel is set to test two scenarios: one is a symmetrical 100-Gb/s/λ single carrier TDM coherent PON, while the other is a symmetrical 100-Gb/s/\ TFDM coherent PON based on four subcarrier multiplexing schemes. A physical layer synchronization block for upstream (PSBu) size, XG-PON encapsulation method (XGEM) header size, and the upstream burst guard time are set to 24, 8, and 8 bytes, respectively

First, a single carrier TDM CPON case is tested, which has a 100 Gbps capacity. The number of ONUs is set to 512 to simulate the large number of users in CPON and all the ONUs are set into a single group. Different ONUs have different busy hours and the average latency is shown in FIG. 5, discussed below.

FIG. 5 is a graphical illustration of a plot (500) showing an average latency of a hybrid-switch DBA, a RR DBA algorithm, and a WF DBA algorithm with different traffic loads on each ONU according to at least one embodiment of the present disclosure. As illustrated, a latency of the RR DBA algorithm is lower than the WF DBA algorithm when the network load on each ONU is low. Such results are due to the traffic variation, which can dramatically change the general traffic pattern and lead to the temporal misalignment. When the network load is very large, the WF DBA algorithm is more effective than the RR DBA algorithm. The WF DBA algorithm can generate with a better allocation where all of the ONUs are assigned with bandwidth on demand.

Meanwhile, the hybrid-switch DBA is able to switch between the RR DBA algorithm and the WF DBA algorithm accordingly. When the network load is relatively low, the RR DBA algorithm is selected by the hybrid-switch DBA, while the WF DBA algorithm is activated by the hybrid-switch DBA when the network load is higher. Thus, the hybrid-switch DBA takes advantage of each of the DBA algorithms advantages and assigns the appropriate DBA algorithm for each different situation.

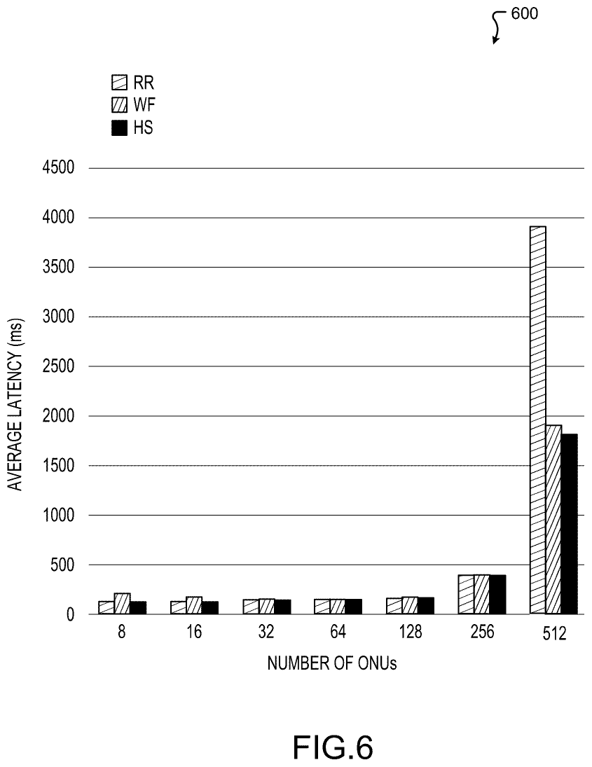

FIG. 6 is a graphical illustration of a plot (600) showing an average latency of the hybrid-switch DBA, the RR DBA algorithm, and the WF DBA algorithm with a different number of ONUs according to at least one embodiment of the present disclosure. In the experimental setup, the basic traffic load of each ONU without the busy hour is set as 0.035 Gbps. As shown, the average latency of the RR DBA algorithm is lower than the WF DBA algorithm when the network load is low, while the WF DBA algorithm performs more efficiently than the RR DBA algorithm when the network load is high. Since the network loads are low when the numbers of ONUs are limited, the WF DBA algorithm has a larger average latency due to the temporal misalignment. Similar to the result shown in FIG. 5, the WF DBA algorithm is more efficient than the RR DBA algorithm when the network load is high. In addition, the hybrid-switch DBA is still able to select the appropriate DBA to be used for different situations.

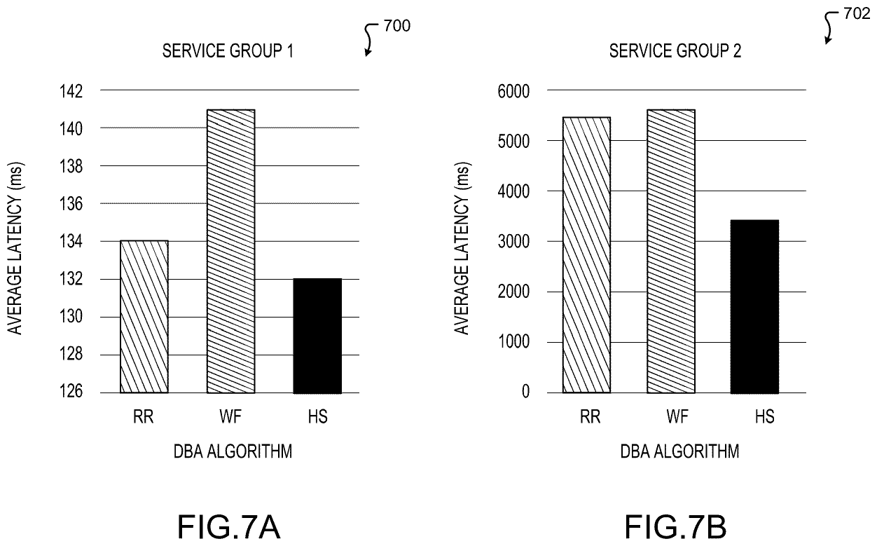

FIG. 7A is a graphical illustration of a plot (700) showing an average latency of the hybrid-switch DBA, the RR DBA algorithm, and the WF DBA algorithm of a first service group and FIG. 7B is a graphical illustration of a plot (702) showing an average latency of the hybrid-switch DBA, the RR DBA algorithm, and the WF DBA algorithm of a second service group according to at least one embodiment of the present disclosure. In the experimental setup, there are four subcarriers, Ch1, Ch2, Ch3, and Ch4, each carrying 25 Gbps. The ONUs are divided into two groups with the different class levels where the ‘first class’ group has 32 ONUs while the ‘normal class’ group has 480 ONUs. In order to guarantee the service of the first-class group, the subcarrier Ch1 is reserved for the first-class group only and Ch2 to Ch4 are reserved for the normal-class group. In this example, the bandwidth reserved for each ONU in the first-class group is larger than the normal-class group. Therefore, the traffic loads of different groups are not the same, which leads to different scales of the misalignment problem. The experimental setup sets the basic traffic load for each ONU is 0.03 Gbps and the busy hour settings are the same as the previous examples described above in FIGS. 5 and 6.

The average latency values in microseconds of the two-subcarrier cases are shown in FIGS. 7A and 7B. As shown, the latency of service group 1 is very low and the hybrid-switch DBA is working effectively as its latency is very close and even lower than the RR DBA algorithm. The service group 1 has a very large bandwidth but limited traffic load so the WF DBA algorithm does not work effectively in reducing latency. In service group 2, the hybrid-switch DBA is able to activate the WF DBA algorithm when the traffic load is very high. The average latency results here show that the hybrid-switch DBA is able to recognize different traffic patterns for different groups and overcome the misalignment problem.

The systems and methods utilizing a hybrid-switch DBA as described herein beneficially reduce latency in a communication system or network and improve the temporal misalignment between network monitoring (e.g., sending status reports) and network management (e.g., execution of a DBA algorithm). The hybrid-switch DBA also beneficially optimizes network performance and can accommodate specific requirements of latency-sensitive applications.

Exemplary embodiments for methods and systems for utilizing a hybrid-switch DBA are described above in detail. The systems and methods of this disclosure though, are not limited to only the specific embodiments described herein, but rather, the components and/or steps of their implementation may be utilized independently and separately from other components and/or steps described herein. Additionally, the exemplary embodiments can be implemented and utilized in connection with other access networks utilizing fiber and coaxial transmission at the end user stage.

The foregoing discussion has been presented for purposes of illustration and description. The foregoing is not intended to limit the disclosure to the form or forms disclosed herein. In the foregoing Detailed Description, for example, various features of the disclosure are grouped together in one or more aspects, embodiments, and/or configurations for the purpose of streamlining the disclosure. The features of the aspects, embodiments, and/or configurations of the disclosure may be combined in alternate aspects, embodiments, and/or configurations other than those discussed above. This method of disclosure is not to be interpreted as reflecting an intention that the claims require more features than are expressly recited in each claim. Rather, as the following claims reflect, inventive aspects lie in less than all features of a single foregoing disclosed aspect, embodiment, and/or configuration. Thus, the following claims are hereby incorporated into this Detailed Description, with each claim standing on its own as a separate preferred embodiment of the disclosure.

Moreover, though the description has included description of one or more aspects, embodiments, and/or configurations and certain variations and modifications, other variations, combinations, and modifications are within the scope of the disclosure, i.e., as may be within the skill and knowledge of those in the art, after understanding the present disclosure. It is intended to obtain rights which include alternative aspects, embodiments, and/or configurations to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A coherent passive optical network (CPON), comprising:
an optical line terminal (OLT) configured to transmit a downstream optical signal to a plurality of optical network units (ONUs) disposed remotely from the OLT and to receive an upstream optical signal from each of the plurality of ONUs, each of the downstream optical signal and the upstream optical signal including one or more data subcarriers;
an optical communication medium in operable communication with the OLT, and configured to transport the downstream optical signal to the plurality of ONUs and to transport the upstream optical signal to the OLT,
wherein a temporal misalignment exists between execution of a DBA algorithm and the OLT receiving a status report from the plurality of ONUs;
a processor; and
a memory storing data for processing by the processor, the data, when processed, causes the processor to:
determine a predetermined switch threshold for each data subcarrier of the one or more data subcarriers;
receiving the status reports from each ONU of the plurality of ONUs;
calculate a current load for each data subcarrier of the one or more data subcarriers based on the status reports;
determine if the current load meets the predetermined switch threshold;
select a first dynamic bandwidth allocation (DBA) algorithm of a plurality of DBA algorithms when the current load does not meet the predetermined switch threshold and a second DBA algorithm of the plurality of DBA algorithms when the current load meets the predetermined switch threshold of at least one predetermined switch threshold; and
execute the selected DBA algorithm,
wherein selecting and executing the selected DBA algorithm improves the temporal misalignment.

2. The CPON of claim 1, wherein the first DBA algorithm comprises at least one of a weighted-fair DBA algorithm, a round-robin DBA algorithm, and a priority queuing DBA algorithm.

3. The CPON of claim 1, wherein the second DBA algorithm comprises at least one of a weighted-fair DBA algorithm, a round-robin DBA algorithm, and a priority queuing DBA algorithm.

4. The CPON of claim 1, wherein the plurality of DBA algorithms comprises more than two DBA algorithms.

5. The CPON of claim 4, wherein the at least one predetermined switch threshold comprises more than one predetermined switch threshold.

6. The CPON of claim 1, wherein the current load comprises a total number of bytes of waiting packets.

7. The CPON of claim 1, wherein determining the at least one predetermined switch threshold includes calculating the at least one predetermined threshold based on a transmission capacity of a DBA cycle, a number of ONUs assigned to a data subcarrier of the one or more data subcarriers, and a threshold factor.

8. The CPON of claim 1, wherein the at least one predetermined switch threshold is determined by a threshold function based on the current load.

9. The CPON of claim 1, wherein the predetermined switch threshold is a first predetermined switch threshold, and wherein the processor is further configured to:
determine if the current load is at least one of less than the first predetermined switch threshold, between the first predetermined switch threshold and a second predetermined switch threshold, or greater than the second predetermined switch threshold;
select the first DBA algorithm when the current load does not meet the first predetermined switch threshold, select the second DBA algorithm when the current load is between the first predetermined switch threshold and the second predetermined switch threshold, and select a third DBA algorithm when the current load is greater than the second predetermined switch threshold; and
execute the selected DBA algorithm.

10. The CPON of claim 1, wherein the processor is further configured to:
monitor the current load over a time period;
determine a traffic pattern based on the current load over the time period; and
adjust the at least one predetermined switch threshold based on the determined traffic pattern.

11. A coherent passive optical network (CPON), comprising:
an optical line terminal (OLT) configured to transmit a downstream optical signal to a plurality of optical network units (ONUs) disposed remotely from the OLT and to receive an upstream optical signal from each of the plurality of ONUs, each of the upstream optical signal and the downstream optical signal including one or more data subcarriers;
an optical fiber in operable communication with the OLT, and configured to transport the downstream optical signal to the plurality of ONUs and to transport the upstream optical signal to the OLT,
wherein a temporal misalignment exists between execution of a DBA algorithm and the OLT receiving a status report from the plurality of ONUs;
a processor; and
a memory storing data for processing by the processor, the data, when processed, causes the processor to:
receive a status report from each ONU of the plurality of ONUs, the status report comprising a queue size of the ONU and one or more network conditions;
calculate a predetermined switch threshold for each data subcarrier of the one or more data subcarriers;
receiving the status reports from each ONU of the plurality of ONUs;
calculate a current load for each data subcarrier of the one or more data subcarriers based on the status reports for each ONU;
determine if the current load meets the predetermined switch threshold;
select a first dynamic bandwidth allocation (DBA) algorithm of a plurality of DBA algorithms when the current load is at least one of less than or equal to the predetermined switch threshold and a second DBA algorithm of the plurality of DBA algorithms when the current load is greater than the predetermined switch threshold of at least one predetermined switch threshold; and
execute the selected DBA algorithm,
wherein selecting and executing the selected DBA algorithm improves the temporal misalignment.

12. The CPON of claim 11, wherein the first DBA algorithm comprises at least one of a weighted-fair DBA algorithm, a round-robin DBA algorithm, and a priority queuing DBA algorithm.

13. The CPON of claim 11, wherein the second DBA algorithm comprises at least one of a weighted-fair DBA algorithm, a round-robin DBA algorithm, and a priority queuing DBA algorithm.

14. The CPON of claim 11, wherein the plurality of DBA algorithms comprises more than two DBA algorithms.

15. The CPON of claim 14, wherein the at least one predetermined switch threshold comprises more than one predetermined switch threshold.

16. The CPON of claim 11, wherein the processor is further configured to:
monitor the current load over a time period;
determine a traffic pattern based on the current load over the time period; and
adjust the at least one predetermined switch threshold based on the determined traffic pattern.

17. The CPON of claim 11, wherein determining the at least one predetermined switch threshold includes calculating the at least one predetermined threshold based on a transmission capacity of a DBA cycle, a number of ONUs assigned to a data subcarrier of the one or more data subcarriers, and a threshold factor.

18. The CPON of claim 11, wherein the at least one predetermined switch threshold is determined by a threshold function based on the current load.

19. The CPON of claim 11, wherein the CPON uses at least one of time-division multiplexing or time and frequency division multiplexing.

20. A method for hybrid-switch dynamic bandwidth allocation (DBA), the method comprising:
calculating a predetermined switch threshold for each data subcarrier of one or more data subcarriers of a downstream optical signal, the downstream optical signal transmitted by an optical line terminal (OLT) to a plurality of optical network units (ONUs) disposed remotely from the OLT;
receiving a status report from each ONU of the plurality of ONUs;
calculating a current load for each data subcarrier of the one or more data subcarriers based on the status report from each ONU;
determining if the current load meets the predetermined switch threshold;
selecting a first DBA algorithm of a plurality of DBA algorithms when the current load does not meet the predetermined switch threshold and a second DBA algorithm of the plurality of DBA algorithms when the current load meets the predetermined switch threshold of at least one predetermined switch threshold; and
executing the selected DBA algorithm.
